(19) United States
(12) Patent Application Publication
(10) Pub. No.: US 2015/0005964 A1
(43) Pub. Date: Jan. 1, 2015

(54) System, Method, and Apparatus for Optimizing Efficient Use of Resources in a Controlled Farming Environment

(71) Applicant: Matthew Liotta, Atlanta, GA (US)

(72) Inventor: Matthew Liotta, Atlanta, GA (US)

(21) Appl. No.: 14/365,561

(22) PCT Filed: Jun. 19, 2012
(86) PCT No.: PCT/US2012/043092

§ 371 Date: Jun. 13, 2014

Related U.S. Application Data
(60) Provisional application No. 61/569,901, filed on Dec. 13, 2011.

(51) Int. Cl. A01G 25/16; G05B 15/02

(52) U.S. Cl. CPC A01G 25/16; G05B 15/02
USPC 700/284; 700/282; 700/90

(57) ABSTRACT

A system, method, and apparatus for optimizing efficient use of resources in a controlled farming environment is disclosed. Various inputs to a controlled farming environment, wherein the controlled farming environment includes a plurality of plants, are controlled based on the nutrition information for the plurality of the plants. Third party information, such as electrical rate information from a power company, can be accessed by the system and may also be utilized to control the inputs to the farming environment. For example, if a power company offers incentives or reduced rates to not utilize power during certain time periods, the system of the present invention will send a signal to the electrical interface to only power the light source to the controlled environment at times other than the certain time period so as to take advantage of the reduced rates or incentives.

### TECHNOLOGICAL FIELD

Embodiments of the present invention relate generally to farming techniques and, more particularly, to a system, method, and apparatus for optimizing efficient use of resources in a controlled farming environment, including without limitation, a hydroponics system.

### BACKGROUND

In years past, farmers were completely dependent on nature for supplying the needs of their crops. The main needs of any plant are water and sunlight. Plants also require certain nutrients, which may receive from the soil via the plants roots. Farmers relied on rain for water, on the sun for light, and on the nutrients in the soil for the crops' nutritional needs. While farmers looking to nature to provide these resources are spared the costs of providing the resources artificially, these farmers face a tremendous uncertainty each year with the unpredictable temperament of nature.

As farming has progressed, farmers have become less dependent on nature for meeting all of these biological needs. With the advent of artificial irrigation, farmers began to control the amount of water received by their crops rather than relying completely on rain. With fertilizer, farmers could increase the amount of nutrients in the soil. With artificial light such as grow lights, farmers can provide the amount of light needed for photosynthesis regardless of the position of the sun.

Therefore, as farming continues to move towards completely man-made environments, there is a need in the art for a system, method, and apparatus to optimize the utilization of resources in these controlled farming environments.

### BRIEF SUMMARY

Therefore, to address the needs and deficiencies described above, the various embodiments of the present invention provide for a system, method, and apparatus for optimizing efficient use of resources in a controlled farming environment, including without limitation, a hydroponics system.

In one embodiment of the present invention, a system for optimizing plant growth in a controlled environment is disclosed, the system comprising: a controller, wherein said controller has a bidirectional communication link to the internet; a valve, wherein said valve is remotely activated and coupled to a water source; a valve interface providing a communication link from the valve to a controller; an electrical source, wherein the electrical source is coupled to one or more light sources; and, an electrical interface providing a communication link from the electrical source and the controller. The controller is configured to receive power rate information from a power company website via the bidirectional communication link, or water rate information from a water company website via the bidirectional communication link. The valve interface may comprise a wireless, or wired, communication link from the valve to the controller.

In another embodiment of the present invention, a method of optimizing plant growth for a plurality of plants in a controlled environment is disclosed. The method comprises the steps of determining nutrition information for one or more plants; ascertaining current levels of inputs in the controlled environment; and, adjusting the inputs to the controlled environment based on the nutrition information and current levels of inputs. The method may further comprise the step of accessing third party input information via a bi-directional communication link to a third party website, such as a power company website wherein the third party input information may comprise electrical rate information.

Determining nutrition information may comprise accessing a nutrition information database via a communication link, receiving a light requirement, or receiving a water requirement for the plurality of plants. The adjusting step may comprise scheduling a light source to be inactive during certain times of the day. The adjusting step may also comprise varying a water valve to provide a predetermined amount of water to the plurality of plants during a predetermined time or amount of time.

In yet another embodiment of the present invention, an apparatus for optimizing plant growth in a controlled environment is disclosed. The apparatus comprises at least one processor; and at least one memory including computer program code, the at least one memory and the computer program code configured to, with the at least one processor, cause the apparatus at least to: determine nutrition information for one or more plants; ascertain current levels of inputs in the controlled environment; and adjust the inputs to the controlled environment based on the nutrition information and current levels of inputs.

Further embodiments of the present invention takes into account the price of CO2 when making adjustments to lighting provided to a plurality of plants by light sources. By increasing CO2, it is possible to lower the light levels from 17 to 12 moles per day. Thus, lowering the amount of light is a savings in the price of power, but also presents an increase in the cost of C02. Therefore, the various embodiments of the present invention dynamically change the inputs to the environment based on the price of power and CO2 to determine an optimal cost strategy.

In yet other embodiments, the present invention may include renewable energy as inputs. As the outputs of various types of renewable energy are variable, and hence, not predictable, the various embodiments of the present invention may be applied to adjust inputs to the controlled environments to address the change in these renewable energy sources.

The at least one memory and the computer program code may be further configured to, with the at least one processor, cause the apparatus to access third party input information via a bi-directional communication link to a third party website. For example, in response to rate information from a power company website, the apparatus, in the adjusting step, may send a signal to an electrical interface to schedule a light source to be inactive during certain times of the day as to take advantage of an incentive offered by the power company or to only use electricity during lower rate time periods. Also, the apparatus may send a signal to a valve interface to schedule water usage for the controlled environment for certain times. The apparatus in this and other embodiments may comprise a controller or any other device capable of controlling one or more inputs in the controlled farming environment.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 illustrates the system according to various embodiments of the present invention.

FIG. 2 further illustrates a system according to an embodiment of the present invention.

FIG. 3 illustrates the controller according to an embodiment of the present invention.

FIG. 4 is a flow diagram illustrating the steps of a method in accordance with an embodiment of the present invention.

FIG. 5 is a flow diagram illustrating the steps of a method in accordance with a specific embodiment of the present invention relating to electrical usage in a controlled farming environment.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

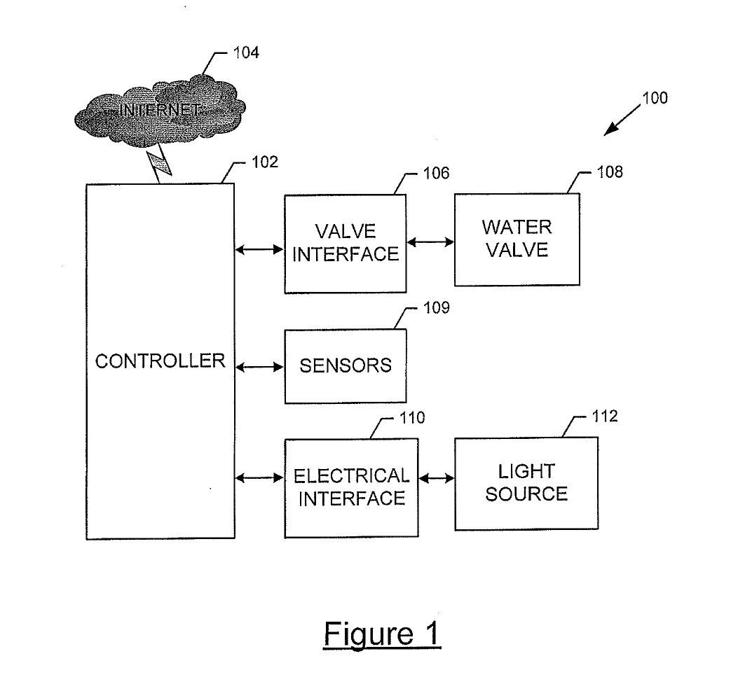

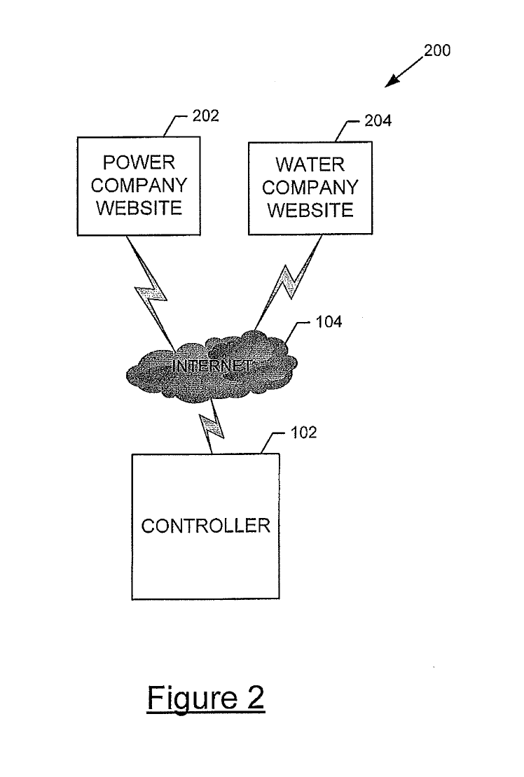

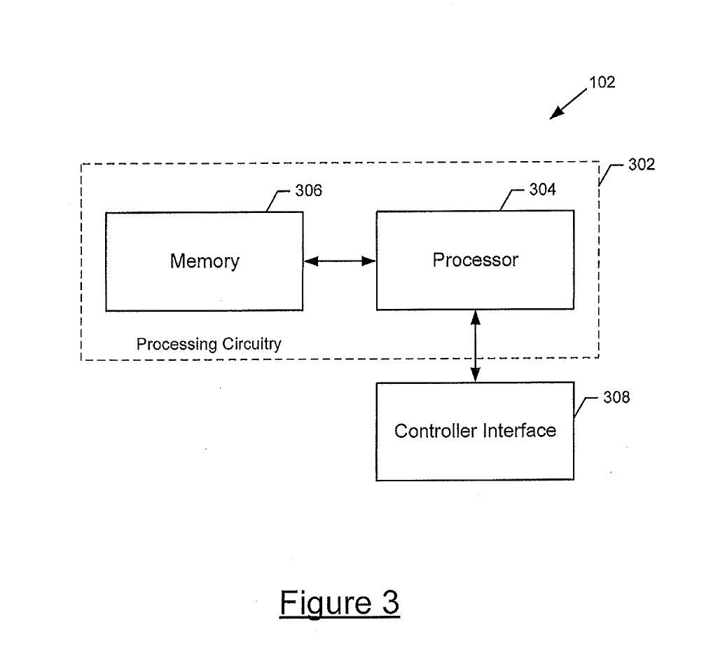

FIG. 1 illustrates the system for optimizing resources in a controlled farming environment according to various embodiments of the present invention. System 100 includes controller 102, which is described in detail in FIG. 3 below. Controller 102 is communicatively coupled to a bidirectional, or unidirectional, communication link to a local or wide area network, such as the internet 104. Via the bidirectional communication link with internet 104, the controller 102 may access one or more network locations to obtain nutrition information and rate information for the various embodiments of the present invention, as described in greater detail in FIG. 2.

System 100 further comprises a valve interface 106 and an electrical interface 110. The valve interface 106 is connected to a water valve 108, and in one embodiment, is configured to receive signals from controller 102 operative to either open the flow of water, or cease the flow of water, to the one or more plants in the controlled farming environment 100. The electrical interface 110 may comprise any type of interface for receiving a signal from controller 102, or in other embodiments, may comprise a user interface for receiving input from a user, and in turn, controlling a light source 112. Light source 112 may comprise any device or means for providing light in a controlled farming environment, including without limitation, a light emitting diode or a collection of light emitting diodes.

Controller 102 may be communicatively coupled to one or more sensors 109, which may be configured to obtain any type of information required or needed by the various embodiments of the present invention. For example, and without limitation, sensors 109 may comprise CO2 sensors to obtain CO2 levels in the controlled farming environment, or light sensors to obtain the amount of light or water received, during a certain period of time, by one or more plants in the controlled farming environment. These sensors are further configured to, after obtaining information from the controlled farming environment, to store this information in a memory 306 or any other computer-readable storage medium. In yet another embodiment of the present invention, these sensors may also be configured to send this information to a computer terminal or smart phone device to elicit input from a user via a user interface.

FIG. 2 further illustrates the portion of the system involving network locations which may include rate or nutritional information for the plants in the controlled environment 100 according to an embodiment of the present invention. As shown in system 200, controller 102 may access, via a bidirectional (or unidirectional) connection with internet 104, one or more network locations. These network locations may comprise, as shown in FIG. 2, a power company website 202 which may publish, a day in advance, rate information for electrical usage. As another example, a network location may comprise a water company website 204 which may publish advance water rate information. Those skilled in the art will appreciate that a number of other network locations may be accessed by controller 102 to obtain rate information or nutrition information, in addition to or instead of, the power company website 202 or water company website 204 within the spirit and scope of the present invention.

FIG. 3 illustrates the controller according to an embodiment of the present invention. As shown in FIG. 3, the controller 102 may include or otherwise be in communication with processing circuitry 302 that is configurable to perform actions in accordance with example embodiments described herein. The processing circuitry 302 may be configured to communicate signals to the valve interface 106 or electrical interface 110, perform data processing, application execution and/or other processing and management services according to an example embodiment of the present invention. The data processing function may comprise analysis of nutrition information for a plurality of plants, along with current input levels and rate information, to determine an adjustment decision for the controlled environment, such as a signal to the electrical interface 110 to only power the light source 112 during certain time periods but in a sufficient amount to meet the nutritional requirements for the plurality of plants.

In some embodiments, the controller 102 or the processing circuitry 302 may be embodied as a chip or chip set. In other words, the controller 102 or the processing circuitry 302 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The controller 102 or the processing circuitry 302 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 302 may include a processor 304 and memory 306 that may be in communication with or otherwise control a controller interface 308. As such, the processing circuitry 302 may be embodied as a circuit chip (e.g., an integrated circuit chip) configured (e.g., with hardware, software or a combination of hardware and software) to perform operations described herein in relation to the controlled farming environment. The controller interface 308 may include one or more interface mechanisms for enabling communication with other devices, such as valve interface 106, sensors 109, electrical interface 108, and/or networks, such as Internet network 104. In some cases, these interface mechanisms may be any means such as a device or circuitry embodied in either hardware, or a combination of hardware and software that is configured to receive and/or transmit data from/to a network and/or any other device or module in communication with the processing circuitry 22. In this regard, the controller interface may include, for example, an antenna (or multiple antennas) and supporting hardware and/or software for enabling communications with a wireless communication network.

In an example embodiment, the memory 306 may include one or more non-transitory memory devices such as, for example, volatile and/or non-volatile memory that may be either fixed or removable (including without limitation flash EEPROM memory). The memory 306 may be configured to store information (such as, without limitation, nutritional information for a plurality of plants in accordance with several example embodiments of the present invention), data, applications, instructions or the like for enabling the controller 102 to carry out various functions in accordance with example embodiments of the present invention. For example, the memory could be configured to buffer input data for processing by the processor 304. Additionally or alternatively, the memory could be configured to store instructions for execution by the processor. Among the contents of the memory, applications may be stored for execution by the processor in order to carry out the functionality associated with each respective application. In some cases, the memory may be in communication with the processor via a bus for passing information among components of the apparatus.

The processor 304 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 306 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

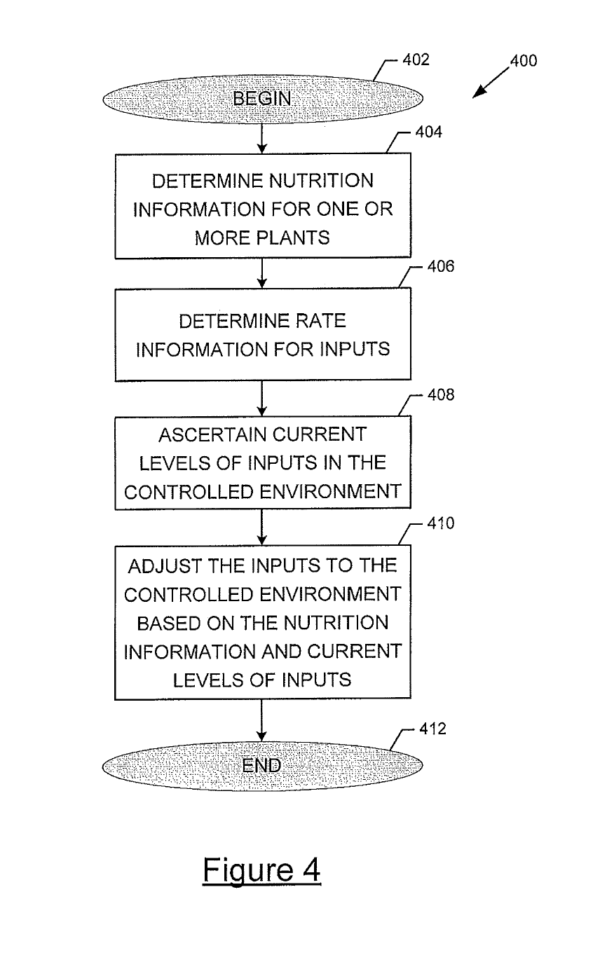

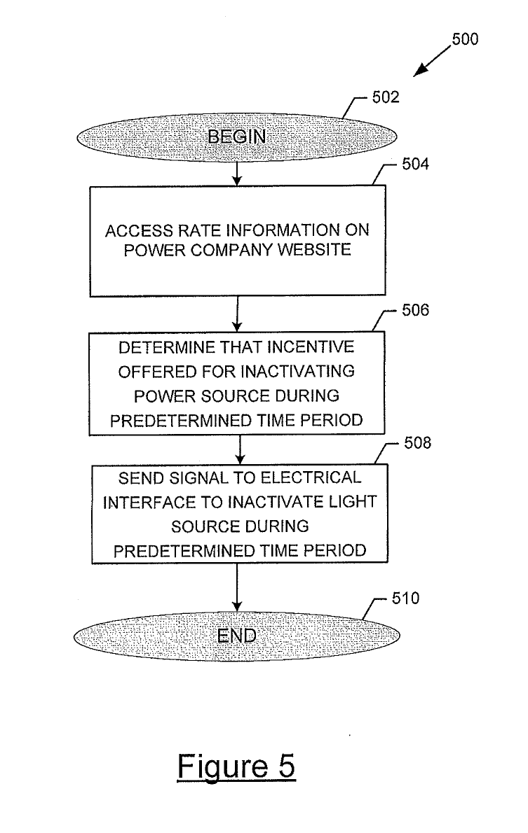

While example embodiments of the present invention have been described above in conjunction with FIGS. 1-3, a flowchart of the operations performed from the perspective of a user is now provided with reference to FIGS. 4-5. It will be understood that each block of the flowcharts, and combinations of blocks in the flowcharts, may be implemented by a user comprising various means, such as hardware, firmware, processor, circuitry, and/or other device associated with execution of software including one or more computer program instructions. For example, one or more of the procedures shown by the flowcharts may be embodied by computer program instructions. In this regard, the computer program instructions which embody the procedures depicted by the flowcharts may be stored by a memory device of an apparatus employing an embodiment of the present invention and executed by a processor in the apparatus.

As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special-purpose hardware-based computer systems which perform the specified functions, or combinations of special purpose hardware and computer instructions.

FIG. 4 is a flow diagram illustrating the steps of a method in accordance with an embodiment of the present invention. Method 400 begins at step 402 and proceeds to determine nutrition information for one or more plants at step 404. Determining nutrition information may comprise any number of methods or processes to obtain data regarding needs of the plurality of plants. For example and without limitation, determining nutrition information may comprise accessing a computer database, computer file such as a Microsoft Excel file, or internet location via a bi-directional or uni-directional communication link to access stored nutritional information. As another example, the nutritional information may be input from a user, beforehand or in real-time, via a user interface.

This nutritional information, in any example, comprises numerical values or quantities needed by the plurality of plants. One of these numerical values may comprise the amount of light needed by the plurality of plants for optimum growth. Lettuce, for example, requires 17 moles of light a day for optimum growth. Any less, or more, light in a 24 hour period will result in either slowed, or improperly accelerated, growth. Thus, the nutritional information may comprise the amount of light required, in moles, which would correspond to a certain amount of hours of light a needed a day to the plants for optimum growth.

At step 406, method 400 determines rates for one or more inputs to the controlled environment. As mentioned previously, these inputs to the controlled environment may comprise any number of inputs required by plants in the growth process. For example, and without limitation, these inputs may comprise light, CO2 levels, water requirements, or other nutritional requirements. To determine the rates for these one or more inputs, the various embodiments of the present invention may access websites, databases, tables, or any other informational resources to obtain rate information, or incentive information, for one or more of the inputs. For example and as discussed in great detail in FIG. 5, step 406 may comprise accessing a power company website and obtaining information, from the power company website, regarding the least expensive times of day to use electricity, or incentives available for ceasing electricity use during certain time of the day or year. Those skilled in the art will appreciate that this rate information may involve any number of inputs, and also, may be stored in any number of locations, within the spirit and scope of the present invention.

At step 408, method 400 ascertains the current levels of the one or more inputs in the controlled environment. To ascertain the current levels, the various embodiments of the present invention may utilize any number of sensors or other information gathering devices to obtain information regarding the current levels of inputs in the controlled environment. These sensors may comprise CO2 sensors, water sensors, light sensors, a computer storage device including historical data regarding the inputs, or any other information gathering device or system which can be used to obtain or access information regarding the various inputs in the controlled environment.

At step 410, method 400 adjusts the inputs to the controlled environment based on the nutrition information and current level of inputs. This adjusting step involves the present invention analyzing the data received from step 408, and considering the current levels with the rate information, making any adjustments that would optimize plant growth and costs incurred in operating the controlled environment. For example, if the plurality of plants comprises lettuce, and in step 406, Method 400 determines that there is a rate incentive for turning off power that day from 8:00 a.m. until 1:00 p.m., the present invention may adjust the inputs to the controlled environment by the controller sending a signal to the electrical interface to turn off the light source from 8:00 a.m. until 1:00 p.m. to take advantage of the incentive. Thus, to provide the 17 moles to the lettuce, the present invention can, via the controller, instruct the electrical interface to power the light source anytime other than 8:00 a.m. from 1:00 p.m. to take advantage of the incentive while providing the necessary light to the lettuce. Those skilled in the art will appreciate that any number of actions may be involved with this adjustment step, but these actions will determine how to provide the necessary inputs to the plurality of the plants while taking advantage of cheapest costs of those inputs or any available incentives relating to those inputs. Method 400 terminates at step 412.

As referenced above, FIG. 5 is a flow diagram illustrating the steps of a method in accordance with a specific embodiment of the present invention relating to electrical usage in a controlled farming environment. Method 500 begins at step 502, and proceeds to access rate information on a power company website at step 504. This rate information may comprise not only costs for using electricity during certain times of the day, but also, may comprise incentive information for refraining from electrical use during certain times of the day.

At step 506, method 500 determines that an incentive is offered for inactivating power source during a predetermined blackout time period, which may be published on a company power website, for example, the previous day. At step 508, method 500 sends a signal to the electrical interface to inactivate the light source during a predetermined period to take advantage of the incentive. To make sure the plurality of plants are still receiving their daily light requirements, the present invention may, via the controller, communicate with the electrical interface to schedule the light source to only be active during times outside the incentive blackout period. Method 500 continues for so long as plants are raised in the controlled farming environment in accordance with the various embodiments of the present invention, and terminates at step 510.

Numerous advantages are provided by the various embodiments of the present invention, with one of these advantages comprising cost savings to the farmer. By providing a system to farmers that can, in real time, determine the least expensive times to provide for their crop's needs, farmers utilizing the present invention will experience significant cost savings not only from using resources when they are least expensive, but also, using resources during time periods when the resource providers, such as power companies, will literally pay the farmers not to use these resources. Thus, the present invention provides a system, method, and apparatus by which these farmers growing plants in a controlled environment, such as hydroponics system, will see a direct increase to their bottom line. By increasing the profitability of such green techniques for growing plants, more farmers will be attracted to the industry, which will in turn have the effect of more local communities enjoying the benefits that can be gained from having local produce on their shelves rather than produce shipped from long distances.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for optimizing plant growth in a controlled environment, the system comprising:
a controller, wherein said controller has a bidirectional communication link to the internet;
a valve, wherein said valve is remotely activated and coupled to a water source;
a valve interface providing a communication link from the valve to a controller;
an electrical source, wherein the electrical source is coupled to one or more light sources; and,
an electrical interface providing a communication link from the electrical source and the controller.

2. The system of claim 1, wherein the controller is configured to receive power rate information from a power company website via the bidirectional communication link.

3. The system of claim 1, wherein the controller is configured to receive water rate information from a water company website via the bidirectional communication link.

4. The system of claim 1, wherein valve interface may comprise a wireless communication link from the valve to the controller.

5. The system of claim 1, wherein the controlled environment comprises a hydroponics farming system.

6. A method of optimizing plant growth for a plurality of plants in a controlled environment, the method comprising:
determining nutrition information for one or more plants;
determining rate information for one or more inputs in the controlled environment;
ascertaining current levels of inputs in the controlled environment; and,
adjusting the inputs to the controlled environment based on the nutrition information and current levels of inputs.

7. The method of claim 6, wherein determining rate information further comprises accessing third party input information via a bi-directional communication link to a third party website.

8. The method of claim 7, wherein third party input information comprises electrical rate information.

9. The method of claim 8, wherein the third party website comprises a power company website.

10. The method of claim 6, wherein determining nutrition information comprises accessing a nutrition information database via a communication link.

11. The method of claim 6, wherein determining a nutrition information comprises receiving a light requirement.

12. The method of claim 6, wherein determining nutrition information comprises receiving a water requirement for the plurality of plants.

13. The method of claim 6, wherein adjusting comprises scheduling a light source to be inactive during certain times of the day.

14. The method of claim 6, wherein adjusting comprises varying a water valve to provide a predetermined amount of water to the plurality of plants during a predetermined time.

15. An apparatus for optimizing plant growth in a controlled environment, the apparatus comprising
at least one processor; and
at least one memory including computer program code, the at least one memory and the computer program code configured to, with the at least one processor, cause the apparatus at least to:
determine nutrition information for one or more plants;
ascertain current levels of inputs in the controlled environment; and,
adjust the inputs to the controlled environment based on the nutrition information and current levels of inputs.

16. The apparatus of claim 15, wherein the at least one memory and the computer program code are further configured to, with the at least one processor, cause the apparatus to access third party input information via a bi-directional communication link to a third party website.

17. The apparatus of claim 15, wherein the at least one memory and the computer program code are further configured to, with the at least one processor, cause the apparatus, in the adjusting step, to send a signal to an electrical interface to schedule a light source to be inactive during certain times of the day.

18. The apparatus of claim 15, wherein the at least one memory and the computer program code are further configured to, with the at least one processor, cause the apparatus, in the adjusting step, to send a signal to an valve interface to schedule a water valve to be inactive during certain times of the day.

19. The apparatus of claim 15, wherein the apparatus comprises a controller.

20. The apparatus of claim 15, wherein current levels of inputs may comprise levels of one or more renewable energy sources.
